(19) United States
(12) Patent Application Publication
(10) Pub. No.: US 2025/0267385 A1
(43) Pub. Date: Aug. 21, 2025

(54) ACOUSTIC SYSTEM

(71) Applicant: Tymphany HK Limited, Hong Kong (HK)

(72) Inventors: Gavin Jones, Taipei City (TW); Garry David Taylor, Taipei City (TW); Fanghui Sun, Taipei City (TW)

(21) Appl. No.: 19/057,498

(22) Filed: Feb. 19, 2025

Related U.S. Application Data
(60) Provisional application No. 63/556,104, filed on Feb. 21, 2024.

(51) Int. Cl. H04R 1/02; E05B 47/00; E05B 65/00; H02J 7/00; H04R 3/00

(52) U.S. Cl. CPC H04R 1/026; E05B 47/0002; E05B 65/00; H04R 1/025; H04R 3/00; H02J 7/007; H02J 2207/20; H04R 2420/07; H04R 2499/13

(57) ABSTRACT

An an acoustic system, which is applied to a vehicle, includes a detachable speaker and a base device. The detachable speaker includes a first housing having a positioning groove, a joining groove and a latching rod arranged in the engagement groove. The base device includes a second housing having an accommodating groove, a positioning member disposed on the lateral wall of the accommodating groove and a locking member disposed on the bottom surface of the accommodating groove. When the detachable audio speaker is selectively joined to the base device, the detachable speaker is accommodated in the accommodating groove, the positioning disc of the positioning member is joined to the positioning groove, and the locking member locks the latching rod.

### CROSS REFERENCE TO RELATED APPLICATIONS

This claims priority of U.S. Provisional Application No. 63/556, 104 filed on Feb. 21, 2024 under 35 U.S.C. § 119 (e), the entire contents of which are hereby incorporated by reference.

### BACKGROUND OF THE INVENTION

### Field of the Invention

The invention relates to a technical field of acoustic technology, and more particularly to an acoustic system.

### Description of the Related Art

As vehicle technologies develop, acoustic systems have become essential equipment for most vehicles. Since the number and mounting positions of speakers may greatly affect the acoustic effect and the speakers of conventional acoustic systems for vehicles are often mounted in predetermined positions, the acoustic effect generated by the conventional acoustic system may be unable to satisfy users' requirements. The users must re-equip new acoustic systems for their further requirements. However, such reequipment incurs costs.

Moreover, as the requirements for various scenarios of utilization in vehicles have increased, the installation of speakers in predetermined positions cannot satisfy the aforementioned requirements (for example, the scenarios of music listening or movie watching) and, thus, provides users with poor experiences.

Therefore, it is an important issue for persons skilled in the art to develop an acoustic system applied to vehicles and satisfying the aforementioned requirements so as to promote users' experiences.

### BRIEF SUMMARY OF THE INVENTION

The present invention provides an acoustic system applied to vehicles, which solves the aforementioned problems of the conventional acoustic system.

The acoustic system in accordance with an exemplary embodiment of the invention includes a detachable speaker and a base device. The detachable speaker includes a first housing having a positioning groove and a joining groove disposed on different surfaces, and a latching rod having two ends connected to two lateral walls of the joining groove respectively, wherein the latching rod is distanced from a bottom of the joining groove. The base device includes a second housing having an accommodating groove, a positioning member disposed at a lateral wall of the accommodating groove and located at a position corresponding to a position of the positioning groove and having a positioning disc, and a locking member disposed at a bottom of the accommodating groove, wherein the locking member is located at a position corresponding to a position of the joining groove. When the detachable speaker is selectively joined to the base device, the detachable speaker is accommodated in the accommodating groove, the positioning disc is joined to the positioning groove, and the locking member locks the latching rod.

As the acoustic system of the invention has the mechanisms designed in the detachable speaker and the base device (i.e., a positioning groove, a joining groove and a latching rod of the detachable speaker, and an accommodating groove, a positioning member and a locking member of the base device), the detachable speaker is selectively joined to the base device. Moreover, the detachable speaker, when separated from the base device, can be placed in an arbitrary position of a vehicle equipped with the acoustic system, thereby providing various sound fields to meet requirements of users. The detachable speaker can also be used in a position external to the vehicle. The acoustic system of the present invention increases the range of utilization experiences for the user.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of an acoustic system of the present invention;

FIG. 2 shows a utilization scenario of the acoustic system of FIG. 1;

FIG. 3 shows a utilization scenario of the acoustic system of the present invention mounted or secured in an interior of a vehicle;

FIG. 4 is an exploded view of a first embodiment of an acoustic system of the present invention viewed at a first viewing angle;

FIG. 5 is an exploded view of a first embodiment of an acoustic system of the present invention viewed at a second viewing angle;

FIG. 6 is an enlarged view of region F in FIG. 5;

FIG. 7 is a block diagram of a circuit of an embodiment of an acoustic system of the present invention;

FIG. 8 is an enlarged view of region G in FIG. 4;

FIG. 9 is an enlarged view of region H in FIG. 5;

FIG. 10 is an enlarged view of region I in FIG. 4;

FIG. 11 is an exploded view of a second embodiment of an acoustic system of the present invention viewed at the first viewing angle;

FIG. 12 is an exploded view of a second embodiment of an acoustic system of the present invention viewed at the second viewing angle;

FIG. 13 is an exploded view of a third embodiment of an acoustic system of the present invention viewed at the first viewing angle;

FIG. 14 is an exploded view of a third embodiment of an acoustic system of the present invention viewed at the second viewing angle;

FIG. 15 is an exploded view of a fourth embodiment of an acoustic system of the present invention viewed at the first viewing angle;

FIG. 16 is an exploded view of a fourth embodiment of an acoustic system of the present invention viewed at the second viewing angle;

FIG. 17 is a block diagram of a circuit of the first embodiment of the acoustic system of the present invention connected to an electronic device; and

FIG. 18 is a block diagram of a circuit of the second embodiment of the acoustic system of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It should be understood that when a component is described as being “connected” or “coupled” to another component, it may be directly connected or coupled to the other component, or indirectly connected or coupled via intervening components. Conversely, when a component is described as being “directly connected” or “directly coupled” to another component, there are no intervening components between them. Furthermore, although the terms “first,” “second,” and so on are used herein to describe different elements, they are solely intended to distinguish elements or operations described using the same technical terminology.

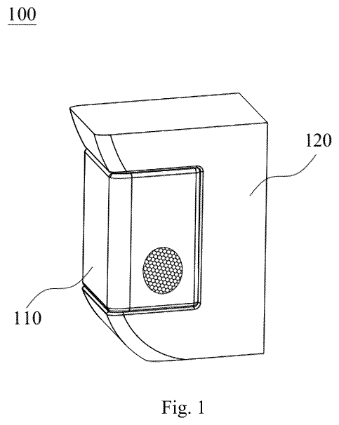

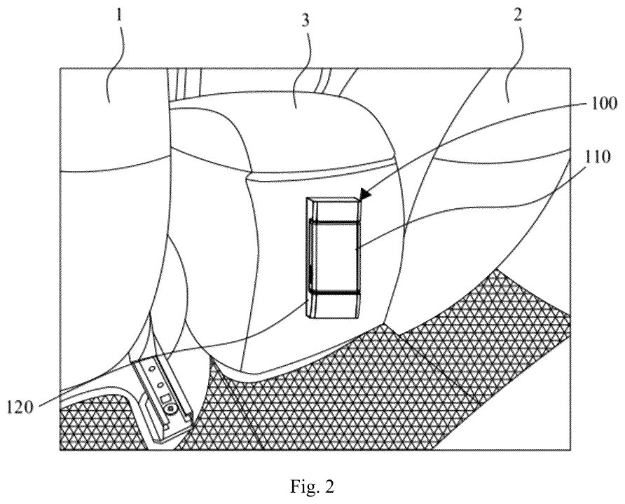

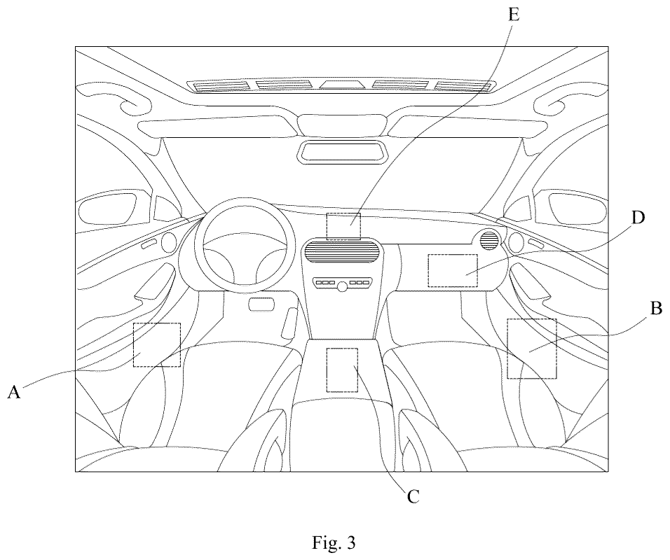

Referring to FIGS. 1 and 2, an acoustic system 100 includes a detachable speaker 110 and a base device 120. The detachable speaker 110 is selectively joined to the base device 120. The acoustic system 100 is applied to vehicles (not shown). Specifically, the base device 120 is secured or mounted to an interior of the vehicle. For example, the base device 120 can be secured or mounted to any desired side of an armrest box 3 between a driver's seat 1 and a front passenger seat 2 (as shown in FIG. 2). The present invention is not limited thereto. The position of the base device 120 secured or mounted in the interior of the vehicle or the number of the acoustic systems 100 for a single vehicle can be adjusted or designed according to requirements (for example the requirements for construction of a sound field). In other words, referring to FIG. 3, the base device 120 can also be secured or mounted to an inner side (a region A) of a door at the driver's seat, an inner side (a region B) of a door at the front passenger's seat, a side (a region C) of the armrest box facing a roof of the vehicle between the driver's seat and the front passenger's seat, an external side (region D) of the glove box in front of the front passenger's seat and/or an upper side (region E) of a dashboard. The present invention is not limited thereto.

Moreover, the base device 120 can be mounted in an interior of a vehicle during construction of the interior or be secured or mounted in the vehicle to meet the demands of users. The method for mounting the acoustic system in the interior of the vehicle can be adjusted according to requirements. For example, the base device 120 can be secured or mounted to the interior of the vehicle by bolts, pins or adhesives.

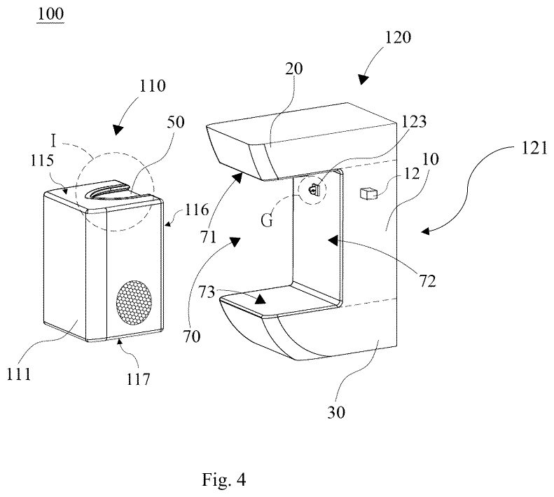

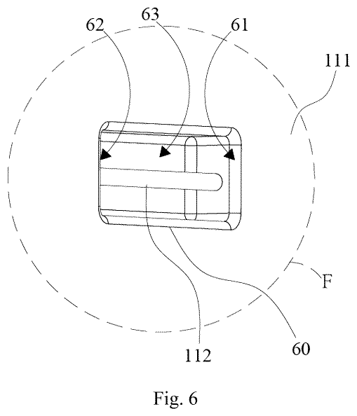

Referring to FIGS. 4 to 6, the acoustic system 100 includes a detachable speaker 110 and a base device 120. The detachable speaker 110 includes a first housing 111 and a latching rod 112. The first housing 111 has a positioning groove 50 and a joining groove 60. Two opposite ends of the latching rod 112 are connected to two opposite lateral walls 61 and 62 of the joining groove 60. The latching rod 112 is distanced from a bottom 63 of the joining groove 60 (i.e., the latching rod 112 has no contact with the bottom 63 of the joining groove 60). The base device 120 is communicationally connected to a vehicle acoustic system (not shown) and includes a second housing 121, a positioning member 122 and a locking member 123. The second housing 121 has an accommodating groove 70. That is, the second housing 121 has a substantially U-shaped structure. The second housing 121 has a central depression serving as the accommodating groove 70. The accommodating groove 70 has a first lateral wall 71, a second lateral wall 72 and a third lateral wall 73. The positioning member 122 is disposed on the first lateral wall 71 of the accommodating groove 70. The positioning member 122 is provided with a positioning disc 122a. The positioning member 122 is located at a position corresponding to a position of the positioning groove 50. The locking member 123 is disposed on the second lateral wall 72 of the accommodating groove 70. The locking member 123 is located at a position corresponding to a position of the joining groove 60.

When the detachable speaker 110 is selectively joined to the base device 120, the detachable speaker 110 is received in the accommodating groove 70 (as shown in FIG. 1). The positioning disc 122a is joined to the positioning groove 50, and the locking member 123 locks the latching rod 112. Therefore, the mechanisms of the detachable speaker 110 and the base device 120 (i.e., a positioning groove 50, a joining groove 60 and a latching rod 112 of the detachable speaker 110, and an accommodating groove 70, a positioning member 122 and a locking member 123 of the base device 120) enable the selective joining of the detachable speaker 110 and the base device 120. Specifically, the positioning groove 50 provides a depressed groove (such as a U-shaped groove) for insertion of the positioning disc 122a. The positioning groove 50 provides a guiding function for the positioning disc 122a smoothly moving into the positioning groove 50 and being tightly fitted thereto, whereby the detachable speaker 110 is fixed to the base device 120 to reduce impact or vibration in the vehicle, and it also reduces the cost of the vehicle and simplifies a structure of docking devices for the vehicle.

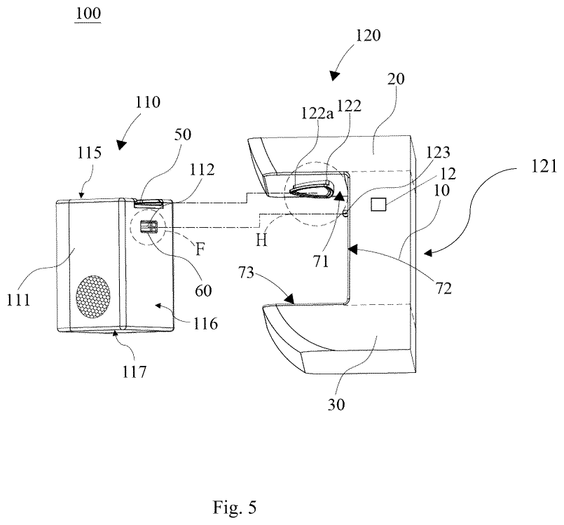

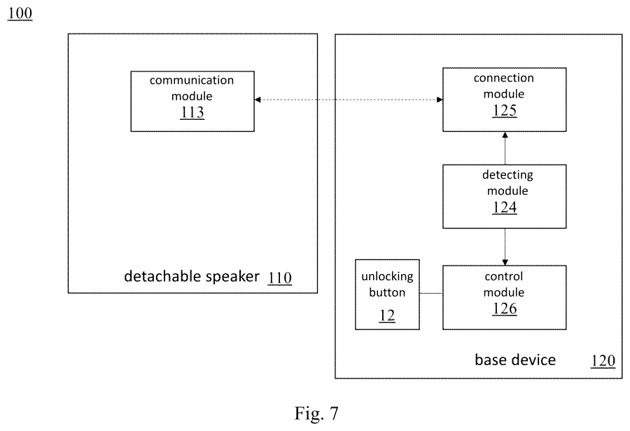

Referring to FIG. 4, FIG. 5 and FIG. 7, the detachable speaker 110 further includes a communication module 113 disposed in the first housing 111. The base device 120 further includes a detecting module 124 and a connection module 125 both disposed in the second housing 121. The detecting module 124 is configured to detect the engagement of the detachable speaker 110 and the base device 120. The connection module 125 is connected to the detecting module 124 and configured to establish a wireless connection with the communication module 113 when the detecting module 124 detects that the detachable speaker 110 is not joined to the base device 120, whereby the detachable speaker 110 synchronously produces sound according to audio signals generated by the acoustic system through the wireless connection between the connection module 125 and the communication module 113. In contrast, when the detecting module 124 detects that the detachable speaker 110 is joined to the base device 120, the detachable speaker 110 is connected to the communication module 113 by a wired connection through the connection module 125 to produce sound according to the audio signal generated by the acoustic system. In addition, in one embodiment, whether or not the detachable speaker 110 is connected to the base device 120, the user can also set the detachable speaker 110 through a control interface (e.g., touch interface) so as to wirelessly connect the detachable speaker 110 to an external device (e.g., a mobile phone) to produce sound according to the audio signals transmitted from the external device.

The base device 110 can be wirelessly connected or connected by a hardwire connection to the acoustic system through the connection module 125, thereby communicating with the acoustic system. The wired connection may include a wired connection for communication through ports such as a USB port and an HDMI port. The wireless connection may include one or more wireless connections for communication through technologies such as Bluetooth, Wi-Fi, and radio frequency. In addition, the detecting module 124 may be mounted on a lateral wall of the accommodating groove 70, and the detecting module 124 may include a distance sensor or a pressure sensor. For example, the distance sensor may be mounted to the second lateral wall 72 of the accommodating groove 70. When the distance sensor detects the distance of the detachable speaker 110 to be less than a default value (for example, 1 cm) for a default time period (for example, 5 seconds), the distance sensor determines that the detachable speaker 110 is joined to the base device 120. The distance sensor may be an infrared sensor, an ultrasonic sensor, or a laser sensor. The pressure sensor can be mounted to the second lateral wall 72 of the accommodating groove 70. When the pressure sensor detects a weight of an object for a default time period (for example, 5 seconds), the pressure sensor determines that the detachable speaker 110 is joined to the base device 120. In addition, the wireless connection between the connection module 125 and the communication module 113 may include one or more wireless connections for communication via Bluetooth, Wi-Fi, radio frequency, and other technologies.

Therefore, through the circuit design of the detachable speaker 110 and the base device 120 (i.e., the base device 110 is connected to the acoustic system of a vehicle in a communicative manner, and when the detecting module 124 detects that the detachable speaker 110 is not joined to the base device 120, the detachable speaker 110 synchronously produces sound according to the audio signals generated by the acoustic system through the wireless connection between the connection module 125 and the communication module 113), the detachable speaker 110 that is not joined to the base device 120 and synchronously produces sound according to the audio signals generated by the acoustic system can be placed at any position within the vehicle, thereby functioning in conjunction with the acoustic system mounted in the vehicle to meet the user's requirements for a sound field and for utilization outside the vehicle to improve the user experience.

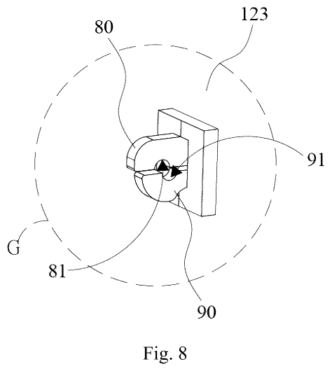

In one embodiment, referring to FIG. 4 and FIG. 8, the locking member 123 may include a first clamping portion 80 and a second clamping portion 90, the first clamping portion 80 is provided with a first clamping groove 81, and the second clamping portion 90 is provided with a second clamping groove 91. The first clamping portion 80 and the second clamping portion 90 are arranged adjacent to each other (for example, the first clamping portion 80 and the second clamping portion 90 are arranged closely together), and the first clamping groove 81 corresponds to the second clamping groove 91 (that is, the opening of the first clamping groove 81 corresponds to the opening of the second clamping groove 91, and the opening of the first clamping groove 81 is opposite to the opening of the second clamping groove 91), whereby when the detachable speaker 110 is selectively joined to the base device 120, the latching rod 112 is pushed between the opening of the first clamping portion 80 and the opening of the second clamping portion 90. The first clamping portion 80 and the second clamping portion 90 are pushed away from each other, whereby the latching rod 112 is pushed between the first clamping groove 81 and the second clamping groove 91 such that the first clamping groove 81 and the second clamping groove 91 lock the latching rod 112 (that is, the locking member 123 is a mechanical lock). Specifically, when the detachable speaker 110 moves toward the base device 120, the latching rod 112 can enter the first clamping groove 81 and the second clamping groove 91 from the depressed portion between the first clamping portion 80 and the second clamping portion 90, whereby the first clamping groove 81 and the second clamping groove 91 can constrain the latching rod 112 due to the depressed design, thereby locking the latching rod 112.

In one embodiment, the locking member 123 may be an electromagnetic locking member (a solenoid locking member), and the base device 120 may also include a control module 126 connected to the electromagnetic locking member (as shown in FIG. 7). The control module 126 is connected to the detecting module 124 and configured to control the locking of the electromagnetic locking member when the detecting module 124 detects that the detachable speaker 110 is joined to the base device 120. For example, the first clamping portion 80 and the second clamping portion 90 can be controlled by the control module 126. The first clamping portion 80 and the second clamping portion 90 may be made of a material that generates a magnetic field through induction, and the latching rod 112 may be made of a material that is attracted by the magnetic field (e.g., iron or ferrous alloy). When the detecting module 124 detects that the detachable speaker 110 is joined to the base device 120, the first clamping groove 81 and the second clamping groove 91 constrain the latching rod 112, and current flows through the control module 126, whereby the first clamping portion 80 and the second clamping portion 90 generate a magnetic field to attract the latching rod 112 (i.e., the electromagnetic locking member is in a locked state), thereby further locking the latching rod 112. In one embodiment, the base device 120 may be provided with an unlocking button 12 (as shown in FIGS. 4, 5, and 7) connected to the control module 126. When the user wants to detach the detachable speaker 110 from the base device 120, the user can press the unlock button 12, whereby the control module 170 controls the electromagnetic locking member to demagnetize so that the user can easily detach the detachable speaker 110. In addition, in one embodiment, the first clamp portion 80 can be made of a material that generates a magnetic field through induction, and the second clamp portion 90 can be made of a material attracted by a magnetic field (e.g., iron). When the detecting module 124 detects that the detachable speaker 110 is joined to the base device 120, the first clamp portion 80 can tightly attract the second clamp portion 90 to constrain the latching rod 112 between the first clamp groove 81 and the second clamp groove 91.

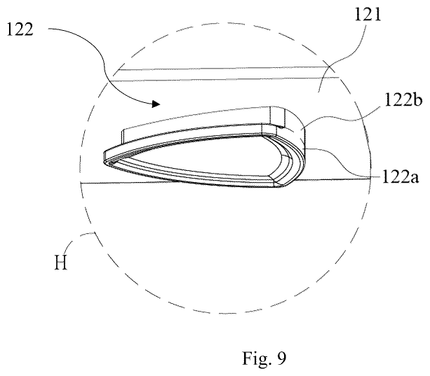

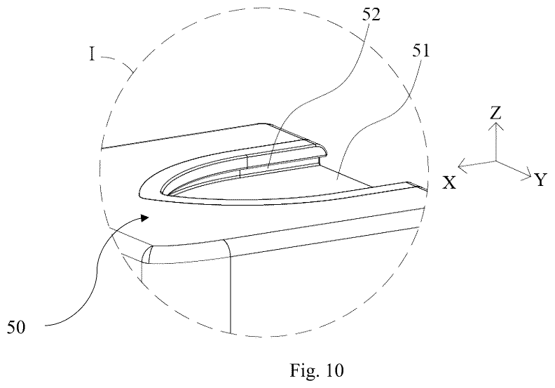

In one embodiment, referring to FIGS. 4, 5, 9 and 10, the positioning member 122 may further include a positioning base 122b, one end of which is connected to the second housing 121 and the other end of which is provided with a positioning disc 122a. The positioning groove 50 may include a mounting groove 51, and a lateral wall of the mounting groove 51 is provided with a limiting groove 52, whereby when the detachable speaker 110 is selectively engaged with the base device 120, the positioning disc 122a can move into the limiting groove 52 along the limiting groove 52, the positioning base 122b is accommodated in the mounting groove 51, and the positioning disc 122a is tightly fitted to the limiting groove 52. The horizontal cross-sectional area of the positioning disc 122a may be greater than that of the positioning base 122b, and the material of the positioning disc 122a may be silicone rubber, or the material surrounding the positioning disc 122a may include silicone rubber to constitute a structure tightly fitted to the limiting groove 52. Therefore, as the positioning base 122b is accommodated in the mounting groove 51 and the positioning disc 122a is tightly fitted to the limiting groove 52, the positioning member 122 is positioned in the X direction, the Y direction, and the Z direction, whereby the positioning member 122 remains stationary during the movement of the vehicle, thereby reducing the possibility of the acoustic system 100 vibrating and producing sounds of rattling and buzzing. In one embodiment, the positioning member 122 may also function as an electromagnetic locking member, at least a portion of the positioning member 122 can be made of a material generating a magnetic field through electromagnetic control, and at least a portion of the positioning groove 50 can be made of a material attracted by the magnetic field (e.g., iron) and corresponds to the position of at least a portion of the positioning member 122 generating a magnetic field. When the detecting module 124 detects that the detachable speaker 110 is joined to the base device 120, at least a portion of the positioning member 122 generates a magnetic field and magnetically attracts at least a portion of the positioning groove 50, thereby securing the positioning member 122 in the positioning groove 50. In particular, in this embodiment, since the positioning member 122 already functions as an electromagnetic locking member, the locking member 123 may be designed to function as only a mechanical locking member without an electromagnetic locking function.

In one embodiment, the mounting groove 51 can be a U-shaped groove or a V-shaped groove.

In one embodiment, the contour of the positioning base 122b may correspond to the contour of the mounting groove 51. That is, the contour shape of the positioning base 122b is similar to or the same as that of the mounting groove 51.

In one embodiment, the second housing 121 is an approximately U-shaped structure, which may include a main body 10, a first protrusion portion 20 and a second protrusion portion 30. The first protrusion portion 20 and the second protrusion portion 30 are disposed at two opposite sides of the main body 10 to form an accommodating groove 70, and the second lateral wall 72 of the accommodating groove 70 is located on the main body 10 (as shown in FIG. 4). In one embodiment, the volume of the accommodating groove 70 is substantially identical to that of the detachable speaker 110, whereby the detachable speaker 110 can be embedded in the accommodating groove 70 and tightly fitted to the accommodating groove 70. The first lateral wall 71, the second lateral wall 72 and the third lateral wall 73 of the accommodating groove 70 respectively cover a top surface 115, a lateral surface 116 and a bottom surface 117 of the detachable speaker 110.

In one embodiment, the positioning member 122 is disposed on the first protrusion portion 20 and the locking member 123 is disposed on the main body 10 (as shown in FIGS. 4 and 5).

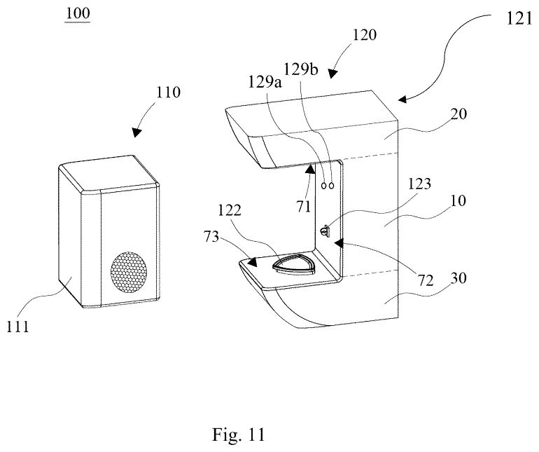

In one embodiment, the positioning member 122 is disposed on the second protrusion portion 30 and the locking member 123 is disposed on the main body 10 (as shown in FIGS. 11 to 14).

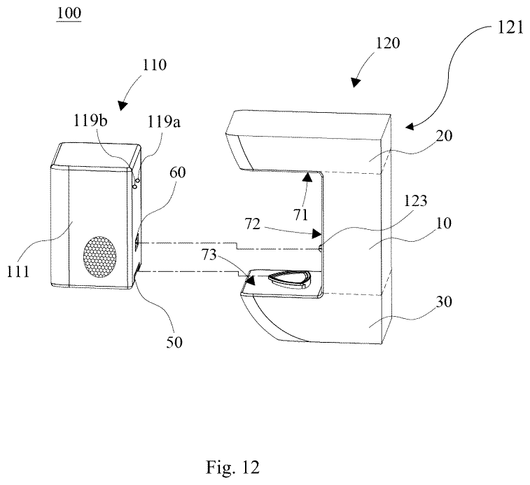

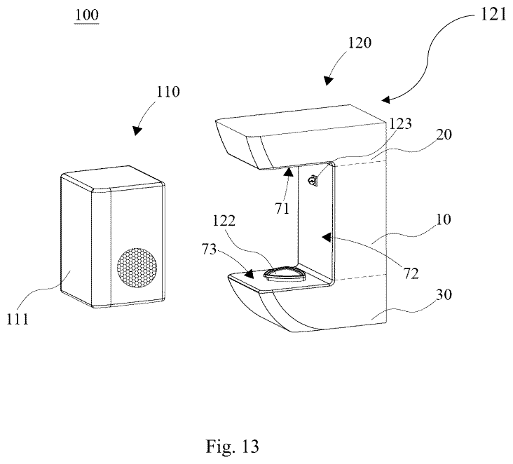

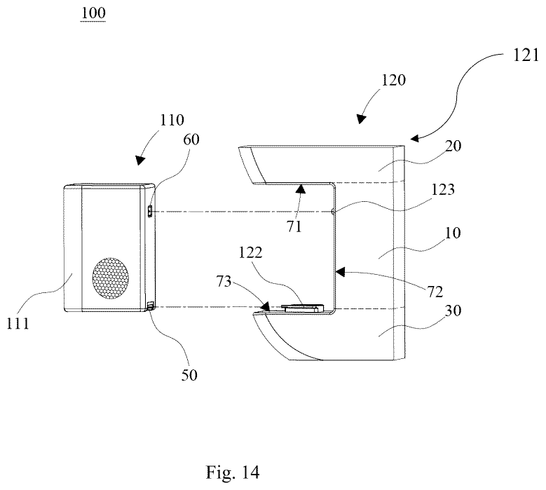

In one embodiment, the locking member 123 disposed on the main body 10 is disposed near the first protrusion portion 20 (as shown in FIGS. 13 and 14) or near the second protrusion portion 30 (as shown in FIGS. 11 and 12). The locking member 123 being close to the first protrusion portion 20 means that a distance between the locking member 123 and the first protrusion portion 20 is smaller than a distance between the locking member 123 and the second protrusion portion 30. The locking member 123 being close to the second protrusion portion 30 means that a distance between the locking member 123 and the second protrusion portion 30 is smaller than a distance between the locking member 123 and the first protrusion portion 20.

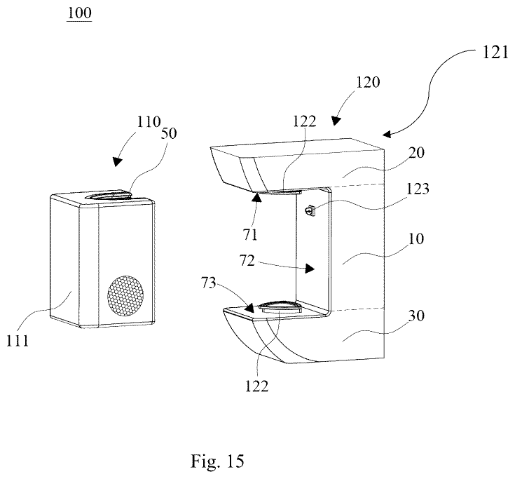

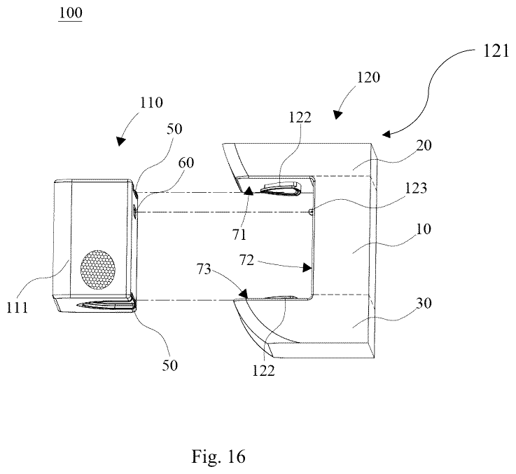

In one embodiment, the locking member 123 is disposed on the main body 10. The number of the positioning members 122 is two, and the number of the positioning grooves 50 is also correspondingly two. The two positioning members 122 are respectively disposed on the first protrusion portion 20 and the second protrusion portion 30 (that is, the two positioning members 122 are respectively disposed on the first lateral wall 71 and the third lateral wall 73 of the accommodating groove 70). The positions of the two positioning grooves 50 correspond to the positions of the two positioning members 122, whereby when the detachable speaker 110 is selectively joined to the base device 120, the positioning discs 122a of the two positioning members 122 engage the two positioning grooves 50 respectively (as shown in FIGS. 15 and 16).

As shown in FIGS. 4, 5, 11 and 16, the different embodiments differ in the mounting positions of the locking member 123 and/or the number and the mounting position of the positioning member 122. The actual mounting position of the locking member 123 and/or the number and mounting position of the positioning member 122 can be adjusted and designed according to actual requirements.

In one embodiment, referring to FIGS. 4, 5 and 17, the detachable speaker 110 may also include a rechargeable battery 114 disposed in the first housing 111, and the rechargeable battery 114 is configured to provide power to the detachable speaker 110. The base device 120 also includes a wireless charging module 127 disposed in the second housing 121, the wireless charging module 127 is connected to the detecting module 124, and a position of the wireless charging module 127 corresponds to a position of the rechargeable battery 114, whereby when the detachable speaker 110 is selectively joined to the base device 120, the wireless charging module 127 wirelessly charges the rechargeable battery 114. It should be noted that the power for the base device 120 can be directly obtained from the acoustic system in the vehicle or the vehicle's power system, and the wireless charging module 127 can wirelessly transmit the obtained power to the rechargeable battery 114, but it is not limited thereto. The way in which the base device 120 obtains power from the acoustic system in the vehicle or the vehicle's power system can be, but is not limited to, the base device 120 being directly connected to the acoustic system in the vehicle or to the vehicle's power system through a power connection cable to obtain power.

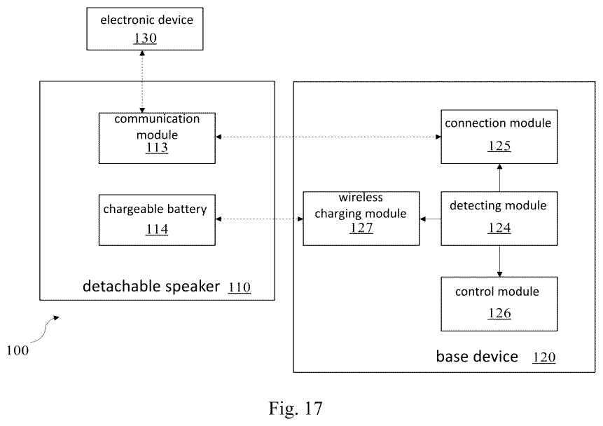

In one embodiment, referring to FIG. 17, when the detecting module 124 detects that the detachable speaker 110 is not joined to the base device 120, the communication module 113 can also selectively establish a wireless connection with an electronic device 130 (for example, a smart phone or a laptop computer) through the user's operation interface (for example, a touch interface) thereon, whereby when the acoustic system in the vehicle is not playing any audio, the detachable speaker 110 produces sound according to the audio signals from the electronic device 130 through the communication module 113. The wireless connection between the electronic device 130 and the communication module 113 includes one or more wireless connections for communication via Bluetooth, Wi-Fi or radio frequency, etc. In one embodiment, when the detachable speaker 110 is not joined to the base device 120, the detachable audio speaker 110 can establish wireless connections with the acoustic system in the vehicle and the electronic device 130 via the communication module 113 at the same time, but the audio signals from the acoustic system are given priority over the audio signals from the electronic device 130. When the acoustic system in the vehicle is deactivated, the detachable speaker 110 will produce sound according to the audio signals from the electronic device.

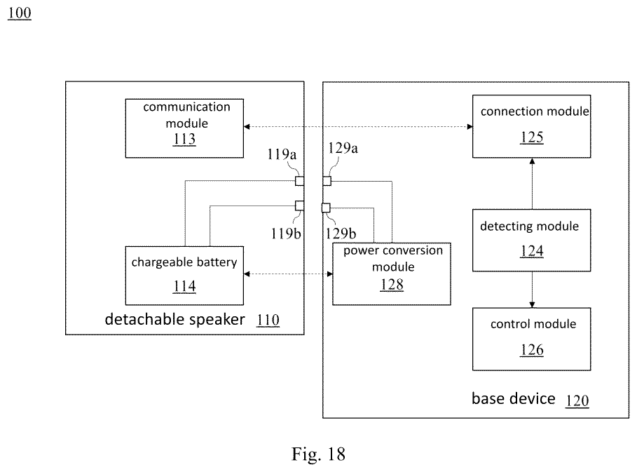

In one embodiment, referring to FIGS. 11, 12 and 18, the detachable speaker 110 shown in FIG. 18 may include, in addition to the communication module 11 of FIG. 7, a rechargeable battery 114 disposed in the first housing 111. The first housing 111 has a first electrode 119a and a second electrode 119b exposed externally. The first electrode 119a and the second electrode 119b are connected to the rechargeable battery 114. The rechargeable battery 114 is configured to provide power for the operation of the detachable speaker 110. In addition to the detecting module 124, the connection module 125 and the control module 126 of FIG. 7, the base device 120 further includes a power conversion module 128 disposed in the second housing 121, a first spring electrode 129a and a second spring electrode 129b (e.g., POGO PIN) exposed externally to the second housing 121 and connected to the power conversion module 128. When the detachable speaker 110 is selectively joined to the base device 120, the first electrode 119a is pressed onto the first spring electrode 129a, the second electrode 119b is pressed onto the second spring electrode 129b, and the power conversion module 128 charges the rechargeable battery 114. Specifically, when the detachable speaker 110 is selectively joined to the base device 120, the power conversion module 128 converts the power obtained from the acoustic system in the vehicle or the vehicle's power system into a default voltage (for example, 5 volts) and then charges the rechargeable battery 114 with the default voltage.

As aforementioned, in the acoustic system of the present application, the detachable speaker and the base device have specified mechanisms (that is, the positioning groove, the joining groove and the latching rod of the detachable speaker and the accommodating groove, the positioning member and the locking member of the base device) whereby the detachable speaker can be selectively joined to the base device. In addition, the detachable speaker, when not connected to the base device, can be placed at any position in the vehicle to work in conjunction with the acoustic system installed in the vehicle to meet the user's requirements for the desired sound field, or it can be used outside the vehicle, thereby improving the user experience. In addition, through the circuit design of the detachable speaker and the base device (that is, the base device is connected to the acoustic system of the vehicle in a communicative manner), the detachable speaker not connected to the base device can produce sound according to the audio signals played by the acoustic system in the vehicle synchronously through the wireless connection between the connection module and the communication module.

While the invention has been described by way of example and in terms of preferred embodiments, it is to be understood that the invention is not limited thereto. On the contrary, the invention is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An acoustic system utilized in vehicles, comprising:
a detachable speaker, comprising:
a first housing having a positioning groove and a joining groove disposed on different surfaces; and
a latching rod having two ends connected to two lateral walls of the joining groove respectively, and being distanced from a bottom of the joining groove;
a base device, comprising:
a second housing having an accommodating groove;
a positioning member disposed at a lateral wall of the accommodating groove and located at a position corresponding to a position of the positioning groove, the positioning member comprising a positioning disc; and
a locking member disposed at a bottom of the accommodating groove, and located at a position corresponding to a position of the joining groove,
wherein, when the detachable speaker is selectively joined to the base device, the detachable speaker is accommodated in the accommodating groove, the positioning disc is joined to the positioning groove, and the locking member locks the latching rod.

2. The acoustic system as claimed in claim 1, wherein the locking member comprises:
a first clamping portion having a first clamping groove; and
a second clamping portion having a second clamping groove, the first clamping portion is adjacent to the second clamping portion,
wherein an opening of the first clamping groove corresponds to an opening of the second clamping groove, and
wherein, when the detachable speaker is selectively joined to the base device, the latching rod is pushed into the portions between the openings of the first clamping groove and the second clamping groove so as to move the first clamping portion and the second clamping portion away from each other, whereby the latching rod is pushed into a portion between the first clamping groove and the second clamping groove and latched by the first clamping groove and the second clamping groove.

3. The acoustic system as claimed in claim 1, wherein the detachable speaker further comprises a communication module disposed in the first housing, and
wherein the base device further comprises:
a detecting module disposed in the second housing and configured to detect a joining condition of the detachable speaker and the base device; and
a connection module disposed in the second housing and connected to the detecting module,
wherein the connection module is wirelessly connected to the communication module when a disconnection of the detachable speaker and the base device is detected by the detecting module, whereby the detachable speaker produces sound according to audio signals generated by the acoustic system through the wireless connection of the connection module and the communication module.

4. The acoustic system as claimed in claim 3, wherein the locking member is an electromagnetic locking member,
wherein the base device further comprises a control module connected to the electromagnetic lock, the control module is connected to the detecting module and is configured to enable a lock condition of the electromagnetic locking member when a connection condition of the detachable speaker and the base device is detected by the detecting module,
wherein the base device is provided with an unlocking button connected to the control module, and
wherein, when the unlocking button is pushed, the control module disables the lock condition of the electromagnetic locking member, whereby the detachable speaker is selectively detached from the base device.

5. The acoustic system as claimed in claim 3, wherein the locking member comprises:
a first clamping portion having a first clamping groove; and
a second clamping portion having a second clamping groove, the first clamping portion is adjacent to the second clamping portion,
wherein an opening of the first clamping groove corresponds to an opening of the second clamping groove,
wherein the first clamping portion and the second clamping portion are made of a magnetic material formed by induction, and the latching rod is made of a material of magnetic attraction,
wherein, when the detachable speaker is selectively joined to the base device, the latching rod is latched by the first clamping groove and the second clamping groove, and
wherein when a connection condition of the detachable speaker and the base device is detected by the detecting module, the first clamping portion and the second clamping portion are magnetized to attract the latching rod, thereby constraining the latching rod between the first clamping groove and the second clamping groove.

6. The acoustic system as claimed in claim 3, wherein the detecting module is mounted to a lateral wall of the accommodating groove and the detecting module comprises a distance sensor or a pressure sensor,
wherein a wireless connection between the communication module and an electronic device is established when the disconnection of the detachable speaker and the base device is detected by the detecting module, whereby the detachable speaker produces sound according to audio signals generated by the electronic device and transmitted through the communication module when the acoustic system is deactivated, and
wherein the detachable speaker produces sound according to audio signals generated by the acoustic system through the wired connection of the connection module and the communication module when a connection of the detachable speaker and the base device is detected by the detecting module.

7. The acoustic system as claimed in claim 3, wherein the positioning member is connected to the detecting module,
wherein at least a portion of the positioning member is made of a magnetic material formed by electromagnetic control,
wherein at least a portion of the positioning groove is made of a material of magnetic attraction and corresponding to at least a portion of the positioning member, and
wherein, when a connection of the detachable speaker and the base device is detected by the detecting module, the at least a portion of the positioning member controlled by the detecting module generates a magnetic field to attract the at least a portion of the positioning groove to secure the positioning member in the positioning groove.

8. The acoustic system as claimed in claim 3, wherein the locking member comprises:
a first clamping portion having a first clamping groove; and
a second clamping portion having a second clamping groove, the first clamping portion is adjacent to the second clamping portion,
wherein an opening of the first clamping groove corresponds to an opening of the second clamping groove,
wherein the first clamping portion is made of a magnetic material formed by induction, and the second clamping portion is made of a material of magnetic attraction,
wherein, when the detachable speaker is selectively joined to the base device, the latching rod is latched by the first clamping groove and the second clamping groove, and
wherein, when a connection condition of the detachable speaker and the base device is detected by the detecting module, the first clamping portion attracts the second clamping portion, thereby constraining the latching rod between the first clamping groove and the second clamping groove.

9. The acoustic system as claimed in claim 1, wherein the second housing comprises:
a main body;
a first protrusion portion; and
a second protrusion portion,
wherein the first protrusion portion and the second protrusion portion are disposed at two ends of the main body to constitute the accommodating groove, a bottom of which is located on the main body.

10. The acoustic system as claimed in claim 9, wherein the second housing has a U-shaped structure, and
wherein the accommodating groove is a central depression of the second housing.

11. The acoustic system as claimed in claim 9, wherein the positioning member is disposed on the first protrusion portion and the locking member is disposed on the main body.

12. The acoustic system as claimed in claim 9, wherein the positioning member is disposed on the second protrusion portion,
wherein the locking member is disposed on the main body, and
wherein the locking member is in proximity to the first protrusion portion or the second protrusion portion.

13. The acoustic system as claimed in claim 9, wherein the locking member is disposed on the main body,
wherein the base device comprises two the positioning members,
wherein the detachable speaker comprises two the positioning grooves,
wherein the two positioning members are disposed on the first protrusion portion and the second protrusion portion respectively, and
wherein the two positioning grooves are located corresponding to the two positioning members, whereby the positioning discs of the positioning members are joined to the two positioning grooves when the detachable speaker is selectively joined to the base device.

14. The acoustic system as claimed in claim 1, wherein the positioning member further comprises a positioning base, one end of the positing base being connected to the second housing,
wherein the positioning disc is disposed at another end of the positioning base, and the positioning groove comprises a mounting groove and a limiting groove formed on a lateral wall of the mounting groove, whereby the positioning disc moves into the limiting groove along the limiting groove, the positioning base is accommodated in the mounting groove, and the positioning disc is tightly fitted to the limiting groove when the detachable speaker is selectively joined to the base device.

15. The acoustic system as claimed in claim 14, wherein the mounting groove is a U-shaped groove or a V-shaped groove,
wherein the positioning groove has a profile corresponding to that of the mounting groove, and
wherein the positioning disc has a horizontal cross section greater than that of the positioning base.

16. The acoustic system as claimed in claim 14, wherein the positioning disc is made of silicon rubber or the positioning disc has a peripheral portion made of a material comprising silicon rubber.

17. The acoustic system as claimed in claim 1, wherein the accommodating groove has a volume substantially identical to that of the detachable speaker, whereby the detachable speaker is tightly fitted into the accommodating groove when the detachable speaker is selectively joined to the base device.

18. The acoustic system as claimed in claim 1, wherein the detachable speaker further comprises a rechargeable battery disposed in the first housing and providing electrical power to the detachable speaker,
wherein the base device further comprises a wireless charging module disposed in the second housing and connected to the detecting module, and
wherein the wireless charging module is located in a position corresponding to the rechargeable battery, whereby the wireless charging module charges the rechargeable battery when the detachable speaker is selectively joined to the base device.

19. The acoustic system as claimed in claim 1, wherein the accommodating groove has a first lateral wall, a second lateral wall and a third lateral wall, the first lateral wall, the second lateral wall and the third lateral wall cover a top surface, a lateral surface and a bottom surface of the detachable speaker respectively.

20. The acoustic system as claimed in claim 1, wherein the detachable speaker further comprises a rechargeable battery disposed in the first housing, the first housing has a first electrode and a second electrode exposed externally, the first electrode and the second electrode are connected to the rechargeable battery providing electrical power to the detachable speaker,
wherein the base device further comprises a power conversion module disposed in the second housing and a first spring electrode and a second spring electrode connected to the power conversion module, and
wherein, when the detachable speaker is selectively joined to the base device, the first electrode presses the first spring electrode and the second electrode presses the second spring electrode, whereby the power conversion module charges the rechargeable battery.
